(19) United States
(12) Patent Application Publication
(10) Pub. No.: US 2010/0308517 A1
(43) Pub. Date: Dec. 9, 2010

(54) COATED SPRING AND METHOD OF MAKING THE SAME

(76) Inventors: James Edward Goodson, Porter, TX (US); William M. Bailey, Humble, TX (US)

Correspondence Address: CANTOR COLBURN LLP, 20 Church Street, 22nd Floor, Hartford, CT, 06103, US

(21) Appl. No.: 12/478,724

(22) Filed: Jun. 4, 2009

(51) Int. Cl. F16F 1/06; B21F 35/00

(52) U.S. Cl. 267/154; 29/896.9

(57) ABSTRACT

A spring suitable for use in an acidizing wellbore is disclosed. The spring includes a spring member comprising an Ni-base or a Co-base alloy, the spring member having an outer surface. The spring also includes an acidizing fluid resistant coating layer disposed on the outer surface of the spring member. A method of making a spring suitable for use in an acidizing wellbore environment is also disclosed. The method includes forming a spring member comprising an Ni-base or a Co-base alloy, the spring member having an outer surface. The method also includes disposing an acidizing fluid resistant coating layer on the outer surface of the spring member. In an exemplary embodiment, the spring may include a torsion spring used in a flapper valve.

### BACKGROUND

Subsurface safety valves are commonly used in oil or gas wells to prevent the escape of fluids from a producing formation in the event of damage to the well conduits or to the surface elements of the well. Typically such safety valves are incorporated into the production fluid transmission tubing which is inserted through the well casing and extends from the surface of the well to the producing formation. The flow of fluids through this inner tubing string must be interrupted in the event of damage to the upper portions of the casing, the tubing string or to the well head. By positioning these valves at a location below the well surface, for example, below the mudline in an offshore well, the safety valve can be closed to prevent the escape of produced fluids.

Subsurface safety valves (SSVs) which incorporate a closure member which pivots about 90°, also known as a flapper, have been in use for many years. Typically, the flapper is pushed downwardly about 90° by a tube to get it out of the way of the flowpath, thereby biasing a torsion spring, or multiple torsion springs. The tubular member that pushes the flapper out of the way is known as the flow tube. If the flow tube is later moved away from the flapper, the spring bias supplied by the torsion spring returns the flapper about 90° to close the flowpath as the flapper engages a mating seat.

The torsion springs employed in flapper valve type SSVs are generally formed from high strength Ni-base or Co-base alloys, including various NiCoCrMo alloys, that are highly resistant to corrosion in various drilling environments.

Acidizing is a technique for increasing the flow of oil from a well by the use of a quantity of a strong acid, such as concentrated hydrochloric acid, pumped downhole and into the associated rock formation. This acid is pumped or forced under high pressure into a limestone formation, thereby dissolving the limestone, enlarging the cavity and increasing the surface area of the hole opposite the producing formation. The high pressure of the treatment also forces the acid into cracks and fissures enlarging them and resulting in an increased flow of oil into the wellbore. After injection into the limestone formation, the acid and dissolved constituents that are heated in the formation are removed from the wellbore. Flow tube and components of the flapper valve, including the torsion spring, are exposed to the hot acidizing fluid. This acidizing fluid not only contains the hot acid, but also contains the dissolved ionic constituents of the rock formation into which it is injected. The acid and other ionic species contained in the acidizing fluid make this fluid very corrosive. While various corrosion resistant materials have been used in the torsion springs and other components of flapper valve assemblies, it is desirable to improve the corrosion resistance of these components, particularly to corrosion induced by exposure to acidizing fluids.

### SUMMARY

In an exemplary embodiment a spring is disclosed. The spring includes a spring member comprising an Ni-base or a Co-base alloy, the spring member having an outer surface. The spring also includes an acidizing fluid resistant coating layer disposed in the outer surface of the spring member.

In an exemplary embodiment, a method of making a spring is disclosed. The method includes forming a spring member comprising an Ni-base or a Co-base alloy, the spring member having an outer surface. The method also includes disposing an acidizing fluid resistant coating layer on the outer surface of the spring member.

### BRIEF DESCRIPTION OF THE DRAWINGS

Referring now to the drawings wherein like elements are numbered alike in the several Figures:

FIG. 1 is a schematic top plan view of a spring as disclosed herein;

FIG. 2 is a right side view of the spring of FIG. 1;

FIG. 3 is a cross-sectional view of the spring of FIG. 1 taken along section 3-3;

FIG. 4 is a cross-sectional view of the spring of FIG. 1 taken along section 4-4;

FIG. 5 is a cross-sectional view of a second exemplary embodiment of a spring as disclosed herein;

FIG. 6 is a top plan view of an exemplary embodiment of the spring as disclosed herein and an associated flapper valve assembly as disclosed herein;

FIG. 7 is a second exemplary embodiment of the spring as disclosed herein and an associated flapper valve assembly as disclosed herein;

FIG. 8 is a third exemplary embodiment of the spring as disclosed herein and an associated flapper valve assembly as disclosed herein; and

FIG. 9 is a flowchart of an exemplary method of making a spring as disclosed herein.

### DETAILED DESCRIPTION

Applicants have observed transgranular cracking in torsion springs that have been exposed to an acidizing fluid in a downhole environment that may include fluid temperatures up to about 300° F. The torsion springs that exhibited transgranular cracking were formed from conventional Ni-base or Co-base alloys of the type typically used for torsion springs employed in SSVs for use in a wellbore. The transgranular cracking observed is believed to propagate from the outer surface of the spring that is torsionally biased in the wellbore environment due to the exposure of one or more of the acidizing fluid, including the acid, such as HCl, and the dissolved constituents of the earth formation that is exposed to the initial acidizing fluid injected into the well. The corrosive or erosive processes that lead to initiation of a crack may also be exacerbated by the elevated temperature of the post-injection acidizing fluid.

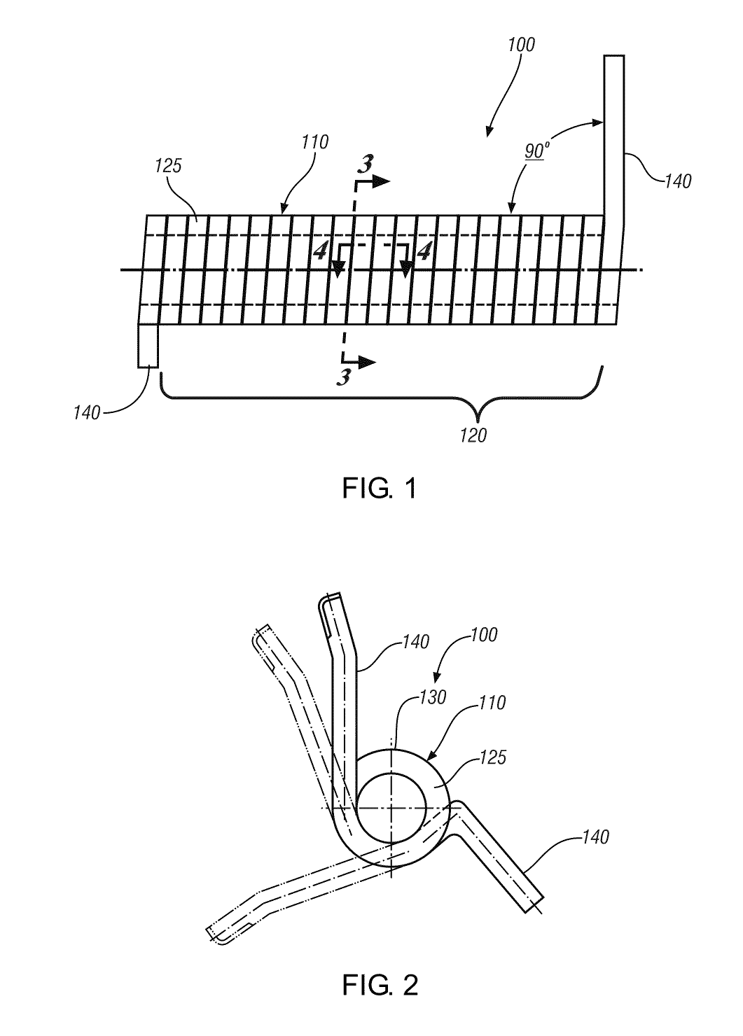

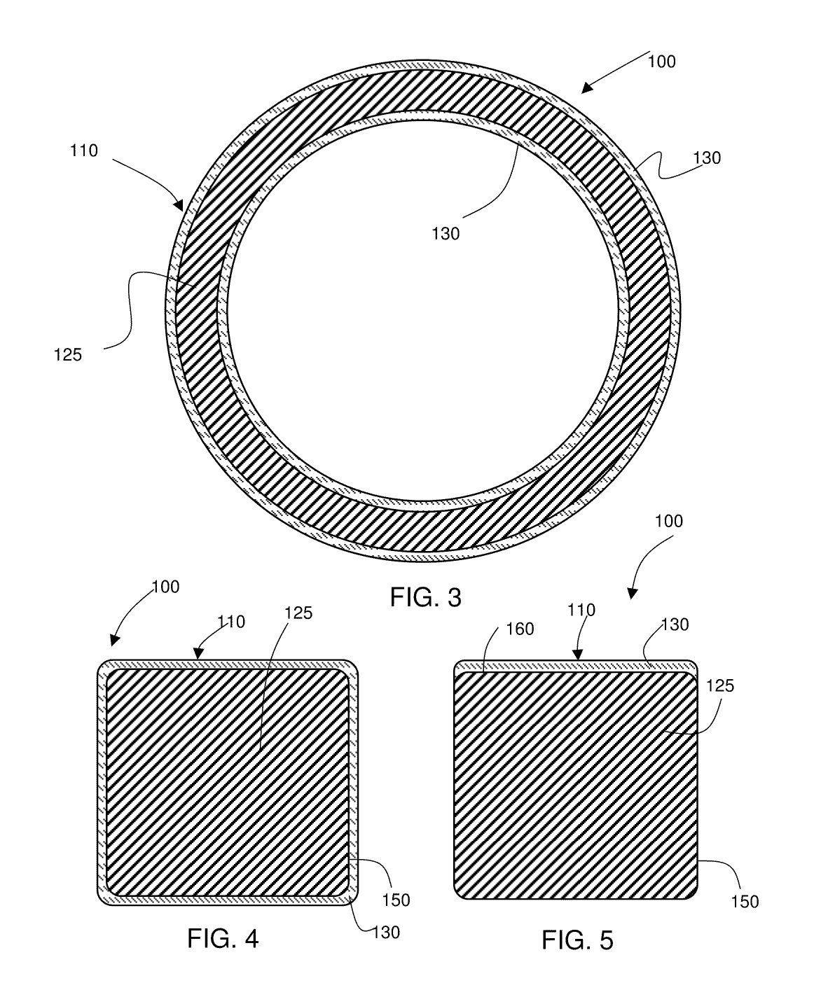

Referring to FIGS. 1-5, a spring 100 for use in an acidizing fluid environment is disclosed. Spring 100 has a reduced propensity for transgranular cracking by virtue of its enhanced acidizing fluid resistance. Spring 100 is also suitable for use in other highly corrosive environments, particularly acidic environments. Spring 100 may include any suitable spring form, including various leaf spring, torsion bar and coil spring forms. Spring 100 may particularly include various coil spring forms employed as torsion or compression springs, and more particularly as torsion springs used in various flapper valve designs, including those employed in SSVs for various wellbore applications. The coil spring forms may be formed from any suitable wire having any suitable cross-sectional shape, including circular, rectangular (e.g. FIGS. 4 and 5), elliptical and arcuate shapes and the like, and these shapes may incorporate features such as radiused, chamfered or other formed transitions between adjoining surfaces (e.g., corners).

Referring again to FIGS. 1-5, in an exemplary embodiment, spring 100 includes spring member 110 having an acidizing fluid resistant coating layer 130 disposed on the outer surface 150 of spring member 110. Spring member 110 may be formed from an Ni-base or a Co-base alloy. More particularly the Ni-base or Co-base alloy may include an NiCoCrMo alloy. Even more particularly, spring member 110 may be formed from an NiCoCrMo alloy including, in weight percent: about 33.0-41.0% Co, about 14.0-37.0% Ni, about 19.0-21.0% Cr and about 6.0-10.5% Mo. In an exemplary embodiment, spring member 110 may be formed from an alloy comprising, in weight percent, about 33.0% Co, about 33.0-37.0% Ni, about 19.0-21.0% Cr and about 9.0-10.5% Mo. This alloy may also include about 0.01% B, about 0.025% or less of C, about 1.0% or less of Fe, about 0.15% or less of Mn, about 0.015% or less of P, about 0.15% or less of Si, about 0.01% or less of S, and about 1.0% or less of Ti. This may include the alloy known commercially as MP35N (UNSR 30035). Alloy MP35N is a multiphase, quaternary, high-strength, ductile alloy having a strength of over 300 ksi. In another exemplary embodiment, spring member 110 may be formed from an NiCoCrMo alloy comprising, in weight percent: about 39.0-41.0% Co, about 14.0-16.0% Ni, about 19.0-21.0% Cr and about 6.0-8.0% Mo. This alloy may also include, in weight percent: about 0.10% or less of Be, about 0.15% or less of C, about 11.25-20.5% Fe, and about 1.5-2.5% Mn. This alloy may include an alloy known commercially as Elgiloy (UNS R30003).

The acidizing fluid resistant coating layer 130 is disposed on outer surface 150 of spring member 110. The outer surface 150 of spring member 110 may be a polished surface. In one exemplary embodiment, outer surface may be polished to a mirror-like finish. Any suitable coating layer 130 may be used, including a metallic or polymer material, or a combination thereof. Suitable metallic materials include Ta, Hf, Zr or Ir. Suitable polymer materials include various fluorocarbon, epoxy, phenolic or ketone polymers, including polytetrafluoroethylene (PTFE) and polyetheretherketone (PEEK). Use of a PTFE nanolayer coating may also take advantage of PTFE's inherent lubricity to lower friction of the spring against other components, such as an alignment rod, and between adjacent coil windings 120 of spring 100. The coating layer may have any suitable thickness. For coating materials having high ductility, relatively thicker coating layers may be employed, including those having a thickness in the range of about 1 to about 1000 μm, and more particularly about 25 to about 130 μm. For coating materials having low ductility, relatively thinner layers may be employed, including those having a thickness of about 50 to about 1000 nm, and more particularly about 50 to about 600 nm. More particularly, for relatively brittle materials, a nanolayer may be employed for coating layer 130, including nanolayers having a thickness of about ≦300 nm.

Referring to FIGS. 1 and 3-5, acidizing fluid resistant coating layer 130 may be disposed uniformly over the outer surface 150 of spring member 110. In the exemplary embodiment illustrated where spring 100 includes spring member 110 that comprises a wire-coil spring body 120 having a plurality of interconnected coil windings 125 and a pair of opposed free ends 140, coating layer 130 may be disposed over substantially all of the outer surface 150 of the spring body 120, including around the entire circumference of coil winding 125, as illustrated in FIG. 4. Alternately, in another exemplary embodiment, coating layer 130 may be disposed on the periphery 160 of outer surface 150 of spring member 110, as illustrated in FIG. 5. In this exemplary embodiment, in the case where spring 100 is a torsion spring, outer surface 150 is in tension while spring 100 is torsionally biased. Thus, disposing coating layer 130 on outer surface 150 coats the portion of spring 100 having a higher propensity for transgranular cracking in an acidizing fluid environment due to the higher strain energy in the microstructure of spring 100 at outer surface 150, and locations within the microstructure proximate this surface. Generalizing this illustration, depending on the configuration of spring 100, coating layer 130 may be disposed on a stress concentrating portion of the outer surface 150 of spring 100, particularly a tensile stress concentrating portion of outer surface 150. The stress concentrating portion of outer surface 150 may vary depending on the configuration of spring 100.

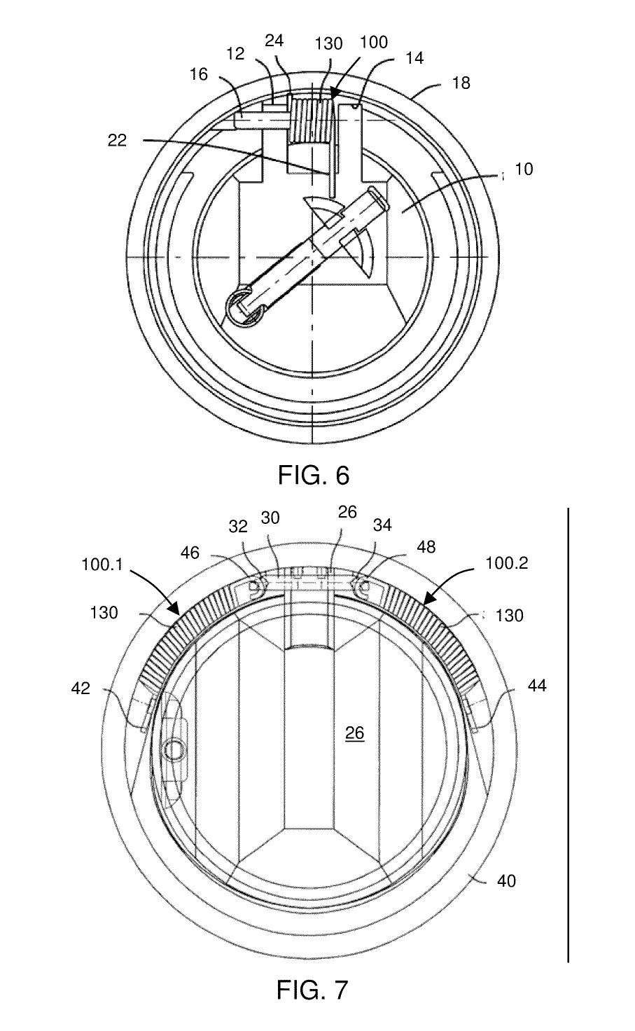

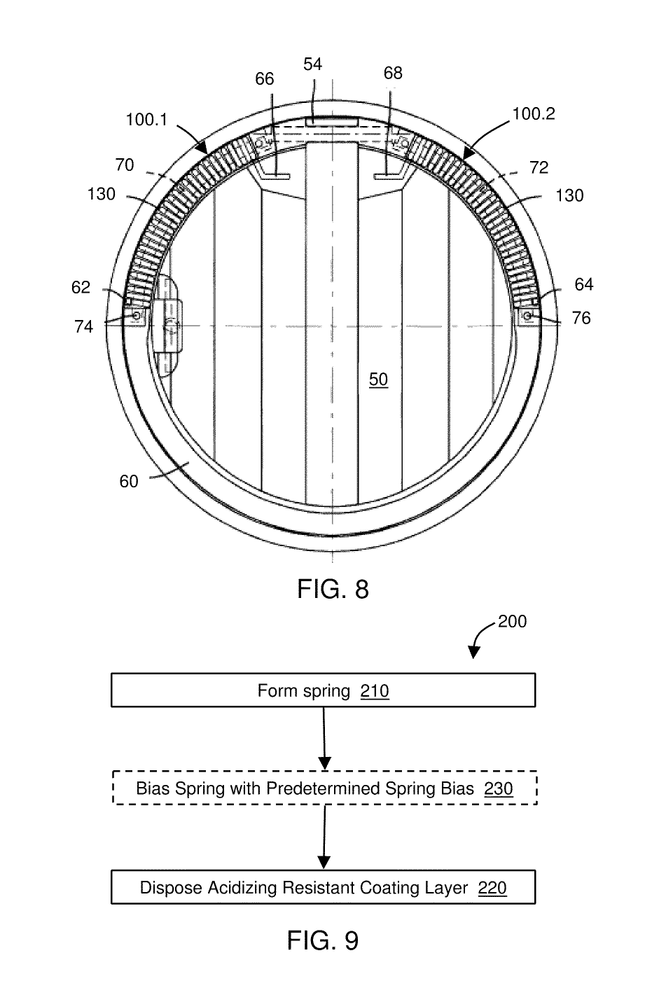

Referring to FIGS. 6-8, spring 100 may include a torsion spring in a flapper valve assembly, such as a flapper valve assembly used in an SSV, including SSVs used in various wellbore configurations. A first exemplary embodiment of a flapper valve assembly is shown in FIG. 6. FIG. 6 illustrates a flapper 10 which has dual hinges 12 and 14, which are secured by pin 16 to the body 18 of the SSV. A torsion spring 100 having an acidizing fluid resistant coating layer 130 disposed thereon has an annular shape and the pin 16 serves as an alignment rod and extends through it as well as through the hinges 12 and 14. A tab 22 comprises the end of the torsion spring 100 and bears on the flapper 10. At the opposite end of the spring 20, another tab 24 is braced against the body 18. When a flow tube (not shown) is pushed down, the torsion spring 100 winds up and is torsionally biased as the flapper 10 is pushed down through an arc of about 90° to get it out of the way so that flow of fluids, such as acidizing fluids, can occur through the flow tube. When the flow tube is allowed to move upwardly, the spring 20, acting through tab 22, initiates the reverse movement through an arc of about 90° of the flapper 10 so that the flapper 10 closes against its mating seat (not shown). This design generally has limited space that in turn forces the use of fairly high stresses in the spring 100 when used in SSVs. The exemplary design of FIG. 6 also has limited torsional closure force available due to the space requirements for fitting spring 100 between hinges 12 and 14. Indeed, some designs do not accommodate the use of dual hinges 12 and 14 and, in those instances, the torsion spring 100 may include a plurality of torsion springs 100, including designs wherein they are disposed circumferentially around the periphery of the flapper, as is more clearly illustrated in FIGS. 7 and 8.

In the exemplary embodiment of FIG. 7, flapper 26 has a single hinge 28. A pin 30 acting as an alignment rod extends through hinge 28 to support the flapper 26 for 90° rotation. Pin 30 has passages or openings 32 and 34 on opposite ends thereof A pair of torsion springs 100.1 and 100.2 are disposed circumferentially adjacent the periphery of the flapper 26. On one end, the torsion springs 100.1 and 100.2 are respectively connected to the body 40 of the SSV at connections 42 and 44. At the other end of torsion springs 100.1 and 100.2, there are hooks 46 and 48. Hooks 46 and 48 extend respectively through openings 32 and 34. Accordingly, when the flapper 26 is pushed downwardly by the flow tube (not shown), the springs 100.1 and 100.2 because of their connections through openings 32 and 34 to the pin 30, resists such movement and coil up or are torsionally biased to store a closing force. Pin 30 rotates with flapper 26, thus rotating the hooks 46 and 48 as the flapper 26 reaches the fully open position of the SSV.

Referring to FIG. 8, the flapper 50 has a hinge 52 through which a flapper pin 54 extends (see FIG. 8). Torsion springs 100.1 and 100.2 are disposed circumferentially about the flapper base 60. Ends 62 and 64 of torsion springs 100.1 and 100.2 are secured to the flapper base 60. Tabs 66 and 68 extend respectively from torsion springs 100.1 and 100.2 into contact with the flapper 50. Those skilled in the art will appreciate that downward rotation of the flapper 50 pushes the tabs 66 and 68 downwardly to store a torsional force in torsion springs 100.1 and 100.2. Guiding the torsion springs 100.1 and 100.2 are alignment rods 70 and 72, respectively. Alignment rods 70 and 72 extend through the coils that comprise the torsion springs 100.1 and 100.2. Pins 74 and 76 respectively connect alignment rods 70 and 72 at one end to the flapper base 60. Torsion spring 100.1 is secured to the flapper base 60 by virtue of a tab (not shown) extending into a groove (not shown). A similar technique is used to attach the end of torsion spring 100.2 to the flapper base 60.

The alignment rods 70 and 72 are connected at the hinge end to the flapper base 60 as shown in FIG. 8. For illustration, rod 72 extends into a groove 82 in the flapper base 60 and its position is fixed by a pin 84, while the pin itself is secured with another pin (not shown) inserted through opening 86. Thus, the alignment rods 70 and 72 do not rotate when the flapper turns. Instead, rotation of the flapper 50 displaces the tabs 66 and 68 so as to torque up or torsionally bias the torsion springs 100.1 and 100.2 around their internal guides which are the alignment rods 70 and 72.

Referring to FIG. 9, a method 200 of making a spring is disclosed. Method 100 includes forming 210 a spring member 110 comprising an Ni-base or a Co-base alloy, the spring member 110 having an outer surface 150. Method 100 also includes disposing 220 an acidizing fluid resistant coating layer 130 on the outer surface 150 of spring member 110. Spring 100 may be made using conventional spring forming methods, including wire drawing and coiling the drawn wire over a mandrel. The acidizing fluid resistant coating layer may be disposed using any suitable method for disposing the coating material on the outer surface 150 of spring member 110, including various deposition methods. Suitable deposition methods include plating, diffusion, chemical vapor deposition or physical vapor deposition, or a combination thereof. Suitable plating methods include ion plating and electrolytic plating. Method 100 may also include biasing 230 the spring body 110 to reduce contact between adjacent coil windings 120 prior to disposing the coating layer. In this way, the spring may be stretched to reduce contact between adjacent coil windings during the deposition process, such that more surface area of spring 100 is exposed to the coating material during the deposition process. In addition, spring 100 may be biased by torquing the spring with a predetermined amount of torque prior to disposing the coating on the outer surface 150 of spring member 110, so that the coating strain would be minimized and subsequent torsional loading of spring 100. For example a predetermined amount of torque, such as about half of the maximum designed torque (or travel of the spring) may be applied during the deposition process.

While one or more embodiments have been shown and described, modifications and substitutions may be made thereto without departing from the spirit and scope of the invention. Accordingly, it is to be understood that the present invention has been described by way of illustrations and not limitation.

We claim:

1. A spring, comprising:
a spring member comprising an Ni-base or a Co-base alloy, the spring member having an outer surface; and
an acidizing fluid resistant coating layer disposed on the outer surface of the spring member.

2. The spring of claim 1, wherein the acidizing fluid comprises HCl at a temperature up to about 300° F.

3. The spring of claim 1, wherein the spring member comprises a torsion spring.

4. The spring of claim 1, wherein the coating layer is disposed uniformly over the outer surface.

5. The spring of claim 1, wherein the coating is disposed on a stress concentrating portion of the outer surface.

6. The spring of claim 3, wherein the torsion spring comprises a wire-coil spring body having a plurality of interconnected coil windings and a pair of opposed free ends.

7. The spring of claim 6, wherein the coating layer is disposed substantially uniformly over the outer surface of the coil windings.

8. The spring of claim 6, wherein the coating layer is disposed on a stress concentrating portion of the outer surface of the spring body.

9. The spring of claim 8, wherein each winding has a periphery and the periphery comprises the stress concentrating portion of the outer surface.

10. The spring of claim 6, further comprising:
an alignment rod that is disposed within the coil windings.

11. The spring of claim 10, wherein the alignment rod comprises an Ni-base or a Co-base alloy.

12. The spring of claim 11, further comprising:
an acidizing fluid resistant coating layer disposed on an outer surface of the alignment rod.

13. The spring of claim 6, further comprising:
a valve body;
a moveable flapper valve pivotally disposed in the valve body and in torsional engagement with the spring, wherein movement of the valve between a closed position and an open position torsionally biases the spring.

14. The spring of claim 13, further comprising:
an alignment rod that is disposed within the coil windings.

15. The spring of claim 1, wherein the spring member comprises an NiCoCrMo alloy.

16. The spring of claim 15, wherein the NiCoCrMo alloy comprises, in weight percent: about 33-41% Co, about 14-37% Ni, about 19-21% Cr and about 6-10.5% Mo.

17. The spring of claim 1, wherein the outer surface is a polished surface.

18. The spring of claim 1, wherein the outer layer comprises a polymer, a ceramic or a metallic material, or a combination thereof.

19. The spring of claim 18, wherein the outer layer comprises Ta, Zr, Hf or Ir, or a combination thereof.

20. The spring of claim 18, wherein the outer layer comprises a fluorocarbon, phenolic, epoxy or ketone polymer.

21. The spring of claim 18, wherein the outer layer comprises a boride.

22. The spring of claim 1, wherein the coating layer has a thickness of about 300 nm.

23. A method of making a spring, comprising:
forming a spring member comprising an Ni-base or a Co-base alloy, the spring member having an outer surface; and
disposing a acidizing fluid resistant coating layer on the outer surface of the spring member.

24. The method of claim 22, wherein the spring comprises a wire-coil spring body having a plurality of interconnected coil windings and a pair of opposed free ends, further comprising:
biasing the spring body to reduce contact between adjacent coil windings prior to disposing the coating layer.

25. The method of claim 22, wherein disposing comprises plating, diffusion, chemical vapor deposition or physical vapor deposition.
